(19) United States
(12) Patent Application Publication
(10) Pub. No.: US 2018/0372095 A1
(43) Pub. Date: Dec. 27, 2018

(54) WATER PUMP

(71) Applicant: O.M.P. OFFICINE MAZZOCCO PAGNONI S.R.L., FUNO (BO) (IT)

(72) Inventors: Giuseppe LO BIUNDO, FUNO (BO) (IT); Francesco PALLANTE, FUNO (BO) (IT)

(21) Appl. No.: 16/019,463

(22) Filed: Jun. 26, 2018

(30) Foreign Application Priority Data
Jun. 27, 2017 (IT) 102017000071484

(51) Int. Cl. F04C 14/22; F01P 5/10; F04C 2/344

(52) U.S. Cl. CPC F04C 14/226; F01P 5/10; F05C 2203/0808; F04C 2240/10; F04C 2240/20; F04C 2/344

(57) ABSTRACT

A water pump with a pump body, a chamber defined inside the pump body, and a rotor rotatable inside the chamber around a rotation axis with a plurality of vanes movable along respective radial directions. A tilting stator is arranged inside the chamber in an eccentric position with respect to the rotor. The tilting stator is pivoted at a rotation pin. A ring is interposed between the tilting stator and the rotor and is in contact with a radially inner surface of the tilting stator and with radially outer ends of the vanes. Adjusting members for adjusting the pump displacement are active on the tilting stator to move the tilting stator with respect to the rotor and place the tilting stator in at least one predetermined operating position defined between a maximum eccentricity position and a minimum eccentricity position.

### CROSS REFERENCE TO RELATED APPLICATIONS

The present application claims priority to Italian Patent Application No. 102017000071484 filed on Jun. 27, 2017, which is incorporated herein by reference in its entirety.

### FIELD

The present disclosure relates to a water pump. Preferably, said water pump is used in the automotive sector, in particular in a cooling circuit of an internal combustion engine. The disclosure also relates to a cooling circuit of an internal combustion engine comprising said water pump.

Reference will be made below in particular to a gasoline or diesel internal combustion engine of a motor vehicle, it being understood, however, that what is said applies more in general also to internal combustion engines of a different type and for other types of vehicles.

The aforementioned water pump may in any case have application in sectors other than the automotive sector, in place of the water pump presently used in those other sectors.

### BACKGROUND

Typically, in order to ensure the correct operation of an internal combustion engine, it is necessary to provide a specific cooling circuit adapted to prevent overheating of the engine.

The cooling circuit typically comprises a water pump, generally driven in rotation by the engine shaft. Such a pump is associated with engine cooling conduits, which generally comprise cavities made in the engine casing, in particular on the walls of the combustion chamber of the engine. Engine cooling takes place through a heat exchange by convection between the engine casing and the cooling water delivered into said cooling conduits by the water pump.

The water pump can also be used to cool other users of the engine, said users being arranged in parallel to the engine. In particular, in the specific case of a gasoline or diesel internal combustion engine, the water delivered by the water pump can also be sent to a heat exchanger in order to condition the oil of the lubrication circuit of the internal combustion engine, whereas in the specific case of a diesel internal combustion engine, the water delivered by the water pump can also be sent to a further heat exchanger to cool the valve for the recirculation of the exhaust gases of the engine.

The water pumps typically used in the cooling circuits of internal combustion engines are centrifugal pumps. These pumps typically comprise a chamber and an impeller housed inside the chamber and adapted to thrust the water, through a respective outlet port, towards the cooling conduits of the internal combustion engine.

### SUMMARY

The Applicant has observed that traditional centrifugal pumps, being driven by the rotation of the engine shaft, continuously pump the water into the cooling circuit of the engine, as well as into any of the heat exchangers mentioned above, starting from the moment in which the engine is started. Such pumps are dimensioned based on the requirements of the hot engine at low number of revolutions. This results in an excessive flow\pressure at high numbers of revolutions, which sometimes makes it necessary to insert a bypass valve (recirculation towards the intake) or modulate the pump speed (by means of an electric drive, electromagnetic or viscostatic clutches, etc.), given that the cooling circuits are not able to withstand high pressures (for example, pressures above 2.5 bar are usually not compatible with standard radiators).

The Applicant has realised that, under some engine operating conditions, it would be advantageous to be able to interrupt, completely or partially, the flow of cooling water towards the engine and/or towards some users. For example, in a cold starting condition (i.e. when the engine is started after a long interruption of operation and is therefore “cold”), the engine does not need to be cooled. Indeed, the circulation of water in the cooling conduits of the engine produces the drawback of increasing the time necessary for the engine to reach the condition of a thermal regime for optimal operation, which in the specific case discussed herein is the one wherein the walls of the engine combustion chamber have temperatures that are sufficiently high to enable a correct combustion inside the engine.

The Applicant has considered how to overcome the drawbacks discussed above with reference to the traditional centrifugal pumps of the prior art, while simultaneously achieving the desired adjustment of the outflow of water from the pump.

The Applicant has realised that this is possible by providing a vane water pump with variable displacement.

The present disclosure thus relates, in a first aspect thereof, to a water pump in accordance with the claims.

The water pump comprises a pump body, a chamber defined inside the pump body, a rotor rotatable inside the chamber around a rotation axis and provided with a plurality of vanes movable along respective radial directions.

The water pump further comprises a tilting stator arranged inside the chamber in an eccentric position with respect to the rotor and pivoted at a rotation pin.

The water pump also comprises a ring interposed between the tilting stator and the rotor and in contact with a radially inner surface of the tilting stator and with radially outer ends of the vanes.

The water pump also comprises adjusting members for adjusting the pump displacement, the adjusting members being active on the tilting stator so as to move the tilting stator with respect to the rotor and position it the tilting stator in at least one predetermined operating position defined between a maximum eccentricity position and a minimum eccentricity position.

Advantageously, thanks to the possibility of adjusting the eccentricity between the tilting stator and the rotor, and consequently the flow of water from the pump, it is possible, by means of such a water pump, to limit that flow in the cold engine starting conditions (so as to more quickly reach the condition of thermal regime for optimal operation of the engine), and to increase the flow in the hot engine operating conditions (so as to satisfy the actual requirements of the engine without the need to provide for the use of bypass valves or modulate the pump speed by means of an electric driver, electromagnetic or viscostatic clutches, etc.).

In a second aspect thereof, the present disclosure relates to a cooling circuit of an internal combustion engine comprising said water pump.

Preferred features of the water pump and of the cooling circuit discussed above are recited in the dependent claims. Unless expressly ruled out, the features of each dependent claim can be used individually or in combination with the ones disclosed in the other dependent claims.

In a first preferred embodiment of the water pump, said adjusting members comprise first thrusting members adapted to exert a first thrusting action on the tilting stator.

Preferably, said first thrusting action is exerted on a first outer surface portion of the tilting stator located substantially on the opposite side to the rotation pin with respect to the rotor.

Preferably, said first thrusting members comprise an elastic element, more preferably a helical compression spring.

Preferably, said adjusting members further comprise at least one thrusting chamber defined between the pump body and the tilting stator and configured to be filled with a predetermined quantity of pressurised fluid (in particular water) to exert a second thrusting action on the tilting stator opposed to said first thrusting action and suitable for moving the tilting stator so as to bring the tilting stator into said at least one predetermined operating position.

More preferably, said at least one thrusting chamber is defined at a second outer surface portion of the tilting stator located between the rotation pin and said first outer surface portion.

In some preferred embodiments thereof, the water pump comprises a further thrusting chamber defined between the pump body and the tilting stator on the opposite side to said at least one thrusting chamber with respect to said rotation pin, said further thrusting chamber being configured to be filled with a predetermined quantity of pressurised fluid (in particular water) to exert a third thrusting action on the tilting stator opposed to said second thrusting action.

Said further thrusting chamber can be used alternatively or in addition to said elastic element. In the former case, the thrusting action exerted by the pressurised fluid present in said further thrusting chamber is suitable for moving the tilting stator so as to bring it into said at least one predetermined operating position. In the latter case, the thrusting action exerted by the pressurised fluid present in said further thrusting chamber is suitable for moving the tilting stator so as to bring it into a further predetermined operating position.

In an alternative embodiment of the water pump, said adjusting members comprise at least one driven actuator active on said tilting stator so as to bring the tilting stator into said at least one predetermined operating position. The driven actuator can be mechanically, electrically, pneumatically or hydraulically driven.

In this embodiment, said tilting stator preferably comprises a connection channel between a first chamber defined between the pump body and the tilting stator and a second chamber defined between the pump body and the tilting stator on the opposite side to said first chamber with respect to the rotation pin, said connection channel being in fluid communication with a suction conduit of the pump.

The provision of said connection channel makes it possible to prevent any leaks of water in said first and second chambers from exerting a thrusting action on the tilting stator.

Said driven actuator can be provided alternatively or in addition to said elastic element. If it is provided in addition to said elastic element, the elastic element performs the function of bringing the tilting stator into a predetermined operating condition in the event of breakage of the actuator.

Preferably, the vanes, the rotor and the tilting stator are made of non-metal materials, such as, for example, carbon graphite or plastic, thermoplastic or thermosetting, materials, with or without fillers or additives. In general, the use of non-metal materials is preferred in order to minimise friction phenomena, and consequently wear on the components in reciprocal contact with relative motion.

More preferably, said vanes are made of carbon graphite. More preferably, said rotor is made of carbon graphite. More preferably, said tilting stator is made of carbon graphite.

The ring can be integral with (for example planted on) the tilting stator (i.e. not rotatable with respect to the stator) or rotatable with respect to the latter by virtue of the thrust exerted by the vanes as a result of the rotation of the rotor.

Said ring is preferably made of carbon graphite. In such a case, the tilting stator can be made of a metal material, such as, for example, aluminium alloys or steel alloys (this solution is preferred if the ring is integral with the tilting stator), or of carbon graphite or plastic, thermoplastic or thermosetting, materials, with or without fillers or additives (this solution is preferred if the ring is rotatable with respect to the tilting stator).

### BRIEF DESCRIPTION OF THE DRAWINGS

Additional features and advantages of the present disclosure will appear more clearly from the following detailed description of a preferred embodiment thereof, made with reference to the accompanying drawings and given for indicative and non-limiting purposes. In the drawings:

FIG. 1 schematically shows a cross section of a first embodiment of the water pump of the present disclosure;

FIG. 2 schematically shows a cross section of a second embodiment of the water pump of the present disclosure.

### DETAILED DESCRIPTION

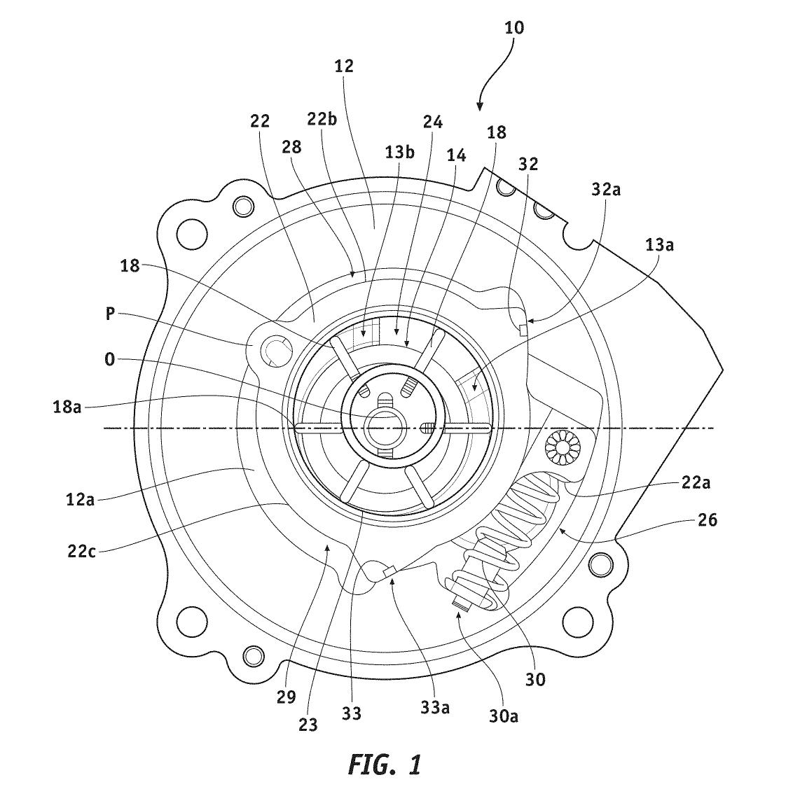

With reference to FIG. 1, it shows a first embodiment of a water pump in accordance with the present disclosure. The water pump is indicated with 10.

The water pump 10 is a variable displacement (or flow) water pump.

The water pump 10 is configured to used in a cooling circuit of an internal combustion engine for motor vehicles, preferably petrol gasoline- or diesel, internal combustion engine.

The pump 10 comprises a pump body 12, inside which a chamber 12a is defined.

A rotor 14 is provided inside the chamber 12a. The rotor 14 is rotatable around a rotation axis O and is provided with a plurality of radial cavities that slidingly house respective vanes 18. For the sake of clarity of illustration, the numerical reference 18 is associated with only two of the vanes illustrated.

A tilting stator 22 is arranged inside the chamber 12a in an outer position with respect to the rotor 14.

The tilting stator 22 is arranged in an eccentric position with respect to the rotor 14.

In the example in FIG. 1, a ring 23 is radially interposed between the tilting stator 22 and the rotor 14. Said ring 23 is in contact with the radially inner surface of the tilting stator 22 and can be integral with the tilting stator 22 or rotatable with respect to the tilting stator 22.

The radially outer ends 18a of the vanes 18 contact, in a hydraulically sealed manner, the radially inner surface of the ring 23. A pressurisation chamber 24 is thus defined between each pair of vanes 18, the ring 23 and the rotor 14. For the sake of clarity of illustration, the numerical reference 24 is associated with only one of the pressurisation chambers illustrated.

The pump body 12 has a water inlet (or intake) opening 13a which leads into a pressurisation chamber 24 from a suction conduit (not illustrated) and a water outlet (or delivery) opening 13b leading from the pressurisation chamber 24 towards the internal combustion engine and possible heat exchangers provided downstream of the water pump 10.

During the rotation of the rotor 14, the volume inside the pressurisation chambers 24 into which water has been fed through the inlet opening 13a is reduced, thus achieving the desired pressure for feeding the water to the engine cooling circuit through the outlet opening 13b.

The tilting stator 22 is pivoted inside the pump body 12 at a rotation pin P and is movable with respect to the rotor 14 between a first position, wherein the eccentricity between the rotation axis O of the rotor 14 and the centre of the tilting stator 22 is minimal, and a second position, wherein the eccentricity between the rotation axis O of the rotor 14 and the centre of the tilting stator 22 is maximum. Said variation in eccentricity causes a variation in the volume of the pressurisation chambers 24 and, consequently, a variation in the flow (or displacement) of the water pump 10.

The rotation pin P can be integrated into the tilting stator 22 and housed in a seat formed in the pump body 12 or, alternatively, integrated into the pump body 12 and housed in a seat formed in the tilting stator 22. Alternatively, the rotation pin P can be an element that is distinct from the pump body 12 and the tilting stator 22 and housed in seats formed on the pump body 12 and on the tilting stator 22.

In the embodiment shown in the drawings, the outlet opening 13b also extends also up to the rotation pin P.

The water pump 10 comprises an elastic element 30, in the specific case illustrated herein a helical spring of the compression type, which is associated, at a first free end 30a thereof, with the pump body 12 and performs a trust action, at the opposite free end thereof, on a first outer surface portion 22a of the tilting stator 22 located on the opposite side to the rotation pin P with respect to the rotor 14.

The water pump 10 further comprises a thrusting chamber 28 defined inside the chamber 12a between the pump body 12 and a second outer surface portion 22b of the tilting stator 22. The thrusting chamber 28 is delimited by the rotation pin P and by a sealing gasket 32 housed in a respective seat 32a formed on the tilting stator 22.

The eccentricity between the rotation axis O of the rotor 14 and the centre of the tilting stator 22 is determined by the balance between the thrusting action exerted by the elastic element 30 on the first outer surface portion 22a of the tilting stator 22 and the opposite thrusting action exerted on the second outer surface portion 22b of the tilting stator 22 by a predetermined quantity of pressurised fluid (in particular water) fed into the thrusting chamber 28.

The elastic element 30 and the thrusting chamber 28, when filled with the pressurised fluid, define adjusting members 26 for adjusting the eccentricity between the rotation axis O of the rotor 14 and the centre of the tilting stator 22, i.e. adjusting members 26 for adjusting the displacement of the water pump 10.

In operation, a predetermined quantity of pressurised fluid is fed into the thrusting chamber 28 to move the tilting stator 22 with respect to the rotor 14 and thereby overcome the thrusting action exerted by the elastic element 30, and to position the tilting stator 22 in a predetermined operating position defined on the basis of the required displacement or flow. A variation in the quantity of fluid fed into the thrusting chamber 28 produces a variation in the eccentricity between the centre of the tilting stator 22 and the rotation axis O of the rotor 14 and, therefore, a variation in the displacement or flow of the water pump 10. Water is fed into the chambers 24 and the water is pressurised by virtue of the decrease in the volume of the chambers 24 as a result of the rotation of the rotor 14. The pressurised water is then fed into the internal combustion engine and possible heat exchangers provided downstream of the water pump 10.

In the example in FIG. 1, the water pump 10 further comprises a further thrusting chamber 29 defined inside the chamber 12a between the pump body 12 and a further outer surface portion 22c of the tilting stator 22. The thrusting chamber 29 is delimited by the rotation pin P and a further sealing gasket 33 housed in a respective seat 33a formed on the tilting stator 22.

Said further thrusting chamber 29, said further outer surface portion 22c of the tilting stator 22, said further sealing gasket 33 and said seat 33a are arranged on the opposite side to the thrusting chamber 28, the outer surface portion 22b of the tilting stator 22, the sealing gasket 32 and the seat 32a, respectively, with respect to the rotation pin P.

The thrusting chamber 29 is likewise configured to be filled with a predetermined quantity of pressurised fluid (in particular water) to exert a further thrusting action on the tilting stator opposed to the one exerted by the pressurised fluid which is inside the thrusting chamber 28 and suitable for moving the tilting stator 22 so as to bring it into a further predetermined operating position.

The thrusting chamber 29 can be used in place of the elastic element 30. In such a case, said adjusting members 26 for adjusting the eccentricity between the rotation axis O of the rotor 14 and the centre of the tilting stator 22, and thus the displacement of the water pump 10, are defined by the thrusting chambers 28 and 29 when they are filled with pressurised fluid.

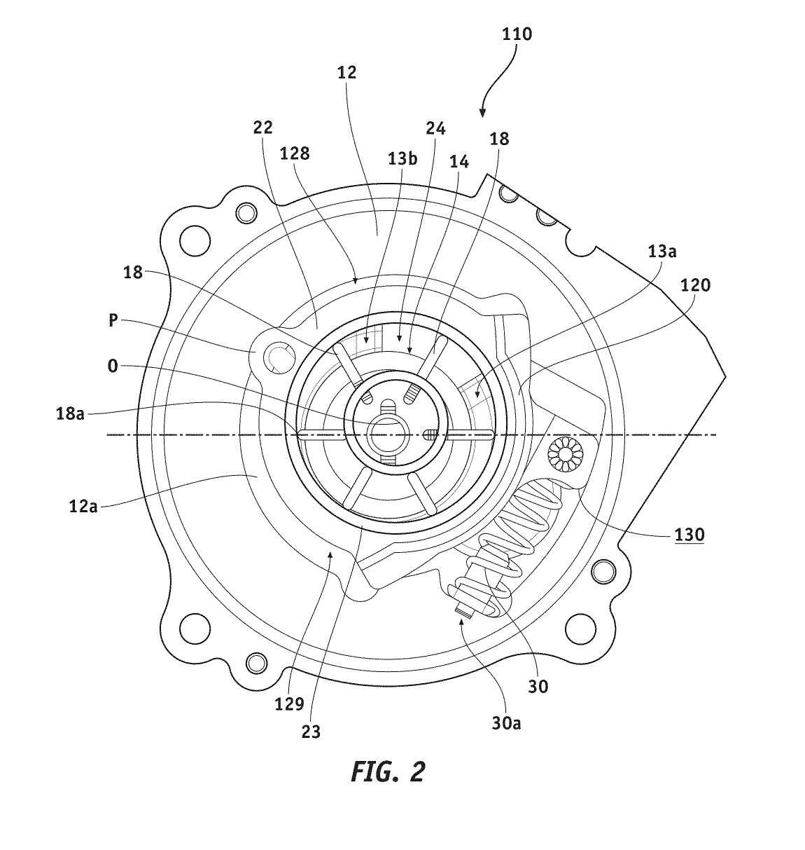

FIG. 2 shows a second embodiment of a water pump in accordance with the present disclosure. The water pump is indicated with 110. In FIG. 2, elements that are structurally or functionally equivalent to those already described with reference to the water pump 10 of FIG. 1 are indicated with the same numerical reference and will not be described again.

The water pump 110 of FIG. 2 differs from the water pump 10 of FIG. 1 only as regards to the details described below. Except for these details, the description provided above with reference to the water pump 10 of FIG. 1 also applies to the water pump 110 of FIG. 2.

Unlike the water pump 10 of FIG. 1, in the water pump 110 of FIG. 2 the adjusting members for adjusting the eccentricity between the rotation axis O of the rotor 14 and the centre of the tilting stator 22, and thus the displacement of the water pump 110, comprise at least one driven actuator 130 active on the tilting stator 22 so as to bring it into the predetermined operating position. The connection between the driven actuator 130 and the tilting stator 22 is exemplified in FIG. 2 by a broken line.

As illustrated in FIG. 2, however, the same elastic element 30 discussed with reference to the water pump 10 of FIG. 1 can also be provided in the water pump 110.

Furthermore, unlike the water pump 10 of FIG. 1, in the water pump 110 of FIG. 2 a connection channel 120 is provided between a first chamber 128 defined between the pump body 12 and the tilting stator 22 and a second chamber 129 defined between the pump body 12 and the tilting stator 22 on the opposite side to the first chamber 128 with respect to the rotation pin P. The connection channel 120 is in fluid communication with the suction conduit of the water pump 110.

The first chamber 128 is arranged in a position substantially analogous to the one of the chamber 28 of the water pump of FIG. 1.

The second chamber 129 is arranged in a position substantially analogous to the one of the chamber 29 of the water pump of FIG. 1.

In both the water pump 10 of FIG. 1 and the water pump 110 of FIG. 2, the vanes 18, the rotor 14, the tilting stator 22 and the ring 23 are made of non-metal material, preferably of carbon graphite or, alternatively, of plastic, thermoplastic or thermosetting, materials, with or without fillers or additives. Alternatively, the tilting stator 22 can be made of a metal material, such as, for example, aluminium alloys or steel alloys.

For the purpose of satisfying specific and contingent needs, a person skilled in the art can make numerous modifications and variants to the water pump 10 described above with respect to FIGS. 1 and 2, all of being which contained within the scope of protection defined by the following claims.

1. A water pump, comprising
a pump body,
a chamber defined inside the pump body,
a rotor rotatable inside the chamber around a rotation axis and provided with a plurality of vanes movable along respective radial directions,
a tilting stator arranged inside the chamber in an eccentric position with respect to the rotor and pivoted at a rotation pin,
a ring interposed between the tilting stator and the rotor and in contact with a radially inner surface of the tilting stator and with radially outer ends of the vanes, and
adjusting members for adjusting pump displacement, the adjusting members being active on the tilting stator to move the tilting stator with respect to the rotor and place the tilting stator in at least one predetermined operating position defined between a maximum eccentricity position and a minimum eccentricity position.

2. The water pump according to claim 1, wherein said adjusting members comprise
first thrusting members adapted to exert a first thrusting action on the tilting stator, and
at least one thrusting chamber defined between the pump body and the tilting stator and configured to be filled with a predetermined quantity of pressurised fluid to exert a second thrusting action on the tilting stator opposed to said first thrusting action and suitable for moving the tilting stator to bring the tilting stator in said at least one predetermined operating position.

3. The water pump according to claim 2,
comprising a further thrusting chamber defined between the pump body and the tilting stator on an opposite side to said at least one thrusting chamber with respect to said rotation pin,
said further thrusting chamber being configured to be filled with a predetermined quantity of pressurised fluid to exert a third thrusting action on the tilting stator opposed to said second thrusting action and suitable for moving the tilting stator to bring the tilting stator in said at least one predetermined operating position or in a further predetermined operating position.

4. The water pump according to claim 1, wherein said adjusting members comprise at least one driven actuator active on said tilting stator to bring the tilting stator in said at least one predetermined operating position.

5. The water pump according to claim 4, wherein said tilting stator comprises
a connection channel between a first chamber defined between the pump body and the tilting stator and
a second chamber defined between the pump body and the tilting stator on the opposite side to said first chamber with respect to the rotation pin, said connection channel being in fluid communication with a suction conduit of the water pump.

6. The water pump according to claim 1, wherein said vanes and said rotor are made of carbon graphite.

7. The water pump according to claim 1, wherein said tilting stator is made of carbon graphite.

8. The water pump according to claim 1, wherein said ring is made of carbon graphite.

9. The water pump according to claim 7, wherein said tilting stator is made of a metal or plastic material.

10. A cooling circuit of an internal combustion engine, comprising the water pump according to claim 1.
